(19) United States
(12) Patent Application Publication
(10) Pub. No.: US 2012/0226586 A1
(43) Pub. Date: Sep. 6, 2012

(54) COMPUTER SYSTEMS AND METHODS FOR INTERACTIVE SHOPPING EXPERIENCE IN RETAIL STORES

(75) Inventor: Lonny Paul, Miami, FL (US)

(73) Assignee: Tigerdirect, Inc., Miami (FL)

(21) Appl. No.: 13/412,329

(22) Filed: Mar. 5, 2012

Related U.S. Application Data
(60) Provisional application No. 61/449,172, filed on Mar. 4, 2011.

(51) Int. Cl. G06Q 30/00

(52) U.S. Cl. 705/26.61

(57) ABSTRACT

In one embodiment, the instant invention includes a computer system of a physical retail store performing the following method that at least includes the steps of: determining a single action performed by a customer to or with at least one physical product, where the at least one physical product is provided in the physical retail store, and where the at least one physical product is accessible to the customer who visit the physical retail store; where the single action is an action that is performed by the visiting customer immediately after or as soon as, and without any intervening action, the visiting customer is in a vicinity of the at least one physical product; and providing to the visiting customer, a product information about the at least one physical product in response to the action performed by the visiting customer.

### RELATED APPLICATIONS

This application claims the benefit of U.S. provisional application Ser. No. 61/449,172, filed Mar. 4, 2011, entitled “METHODS AND COMPUTER ENABLED SYSTEMS FOR COMPARING PRODUCTS SOLD IN A RETAIL STORE USING INTERACTIVE DISPLAYS,” which is hereby incorporated by reference herein in its entirety for all purposes.

### TECHNICAL FIELD

The present invention relates to operations of physical retail stores. Specifically, in some embodiments, the present invention relates to consumers' physically interaction with one or more physical products (e.g., by touching, lifting, playing in hands) offered by and/or at physical retail stores.

### BACKGROUND

A typical retail store may have hundreds or thousands of physical products displayed on store's stands for attracting customers.

### SUMMARY OF INVENTION

In some embodiments, the instant invention can include at least one computer system of a physical retail store performing the following method that can at least include the steps of: determining a single action performed by a customer to or with at least one physical product, where the at least one physical product is provided in the physical retail store, and where the at least one physical product is accessible to the customer who visit the physical retail store; where the single action is an action that is performed by the visiting customer immediately after or as soon as, and without any intervening action, the visiting customer is in a vicinity of the at least one physical product; and providing to the visiting customer, a product information about the at least one physical product in response to the action performed by the visiting customer.

In some embodiments, the single action can be one of the following: a) the visiting customer lifts the at least one physical product from a display of the physical retail store, b) the visiting customer touches the at least one physical product, c) the visiting customer activates in the single action at least one control of the at least one physical product, or d) the visiting customer engages in a dynamic interaction related to the at least one physical product by performing a single movement which is recognized by the at least one physical product or by the computer system of the physical retail store.

In some embodiments, the vicinity of the at least one physical product can further include a plurality of physical products displayed by the physical retail store.

In some embodiments, the providing, by the computer system of the physical retail store, to the visiting customer, the product information about the at least one physical product can further include displaying the product information about the at least one physical product on a monitor located within the vicinity of the at least one physical product.

In some embodiments, the providing, by the computer system of the physical retail store, to the visiting customer, the product information about the at least one physical product can further include receiving, by the computer system of the physical retail store, at least one request regarding the displayed product information about the at least one physical product.

In some embodiments, the receiving, by the computer system of the physical retail store, the at least one request regarding the displayed product information about the at least one physical product can further include allowing the visiting customer to submit the at least one request by interacting with the monitor. In some embodiments, the allowing the visiting customer to submit the at least one request by interacting with the monitor can further include providing a touch screen which is capable of communicating the at least one request that the visiting customer submits by utilizing the touch screen.

In some embodiments, the determining the single action performed by the visiting customer to the at least one physical product can further include determining, by the computer system of the physical retail store, when the visiting customer touches, in the single action, a touch screen of a monitor located within the vicinity of the at least one physical product, where the touch of the visiting customer is within an area of the touch screen which is associated with the at least one physical product.

In some embodiments, the providing, to the visiting customer, the product information about the at least one physical product in response to the action performed by the visiting customer can further include providing, by the computer system of the physical retail store, to the visiting customer, at least one visual or audio indication that identifies the at least one physical product among other physical products located in the vicinity of the at least one physical product. In some embodiments, the at least one visual or audio indication is produced by the at least one physical product. In some embodiments, the at least one visual or audio indication is produced by a location of the at least one physical product.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 illustrates an embodiment of the present invention.

FIG. 2 illustrates another embodiment of the present invention.

FIG. 3 illustrates yet another embodiment of the present invention.

FIG. 4 illustrates yet another embodiment of the present invention.

FIG. 5 illustrates yet another embodiment of the present invention.

FIGS. 6A-6B illustrate yet another embodiments of the present invention.

FIG. 7 illustrates yet another embodiment of the present invention.

FIG. 8 illustrates yet another embodiment of the present invention.

FIGS. 9A-9B illustrate yet another embodiments of the present invention.

FIG. 10 illustrates yet another embodiment of the present invention.

FIG. 11 illustrates yet another embodiment of the present invention.

FIG. 12 illustrates yet another embodiment of the present invention.

FIG. 13 illustrates yet another embodiment of the present invention.

FIG. 14 illustrates yet another embodiment of the present invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In addition, as used herein, the terms “real time” means without undue delay and to be performed within a single time communication session while a potential customer is in a vicinity of a particular displayed physical product for which the potential customer desires information and/or in a vicinity of a set of displayed physical products that include a particular physical product for which the potential customer desires information.

In addition, as used herein, the term “information” can include an action/activity to be performed.

In addition, as used herein, the term “the retail store” can include one or more physical stores (e.g., a plurality of stores controlled by the same company—a chain of CompUSA stores).

In some embodiments, the inventive computer system and methods allows for dynamic and interactive shopping experience at a point-of-sale (POS) (e.g., a retail store) by enticing potential customers to physically interact with physical items sold at a retail store.

### Illustrative Operating Environments for Operating Electronic Products Displayed in the Retailed Store

### Example 1

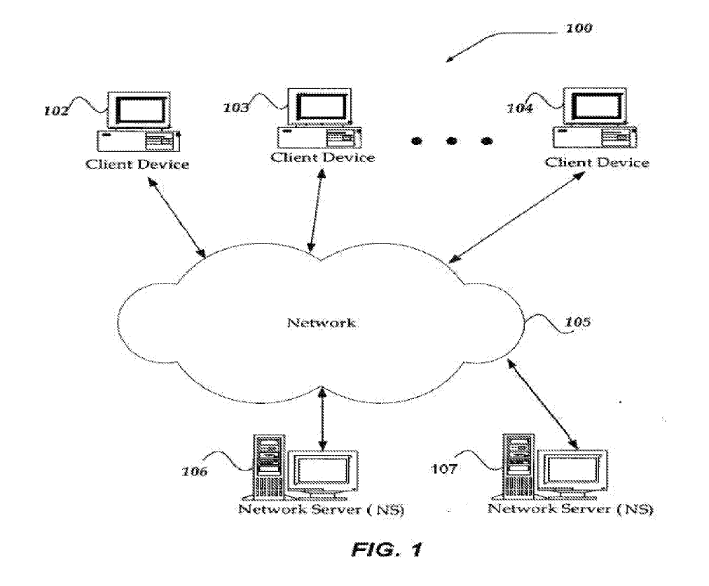

FIG. 1 illustrates one embodiment of an environment in which the present invention may operate. However, not all of these components may be required to practice the invention, and variations in the arrangement and type of the components may be made without departing from the spirit or scope of the invention. In some embodiment, the inventive system hosts a large number of members and concurrent transactions. In other embodiments, the inventive system computer is based on a scalable computer and network architecture that incorporates varies strategies for assessing the data, caching, searching, and database connection pooling. An example of the scalable architecture is an architecture that is capable of operating multiple servers.

In embodiments, client electronic devices 102-104 (electronic devices in a retail store) include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each client device within client devices 102-104 includes a browser application that is configured to receive and to send web pages, and the like. In embodiments, the browser application is configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like. In embodiments, the invention is programmed in either Java or .Net.

In embodiments, client devices 102-104 are further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

In embodiments, network 105 is configured to couple one computing device to another computing device to enable them to communicate. In embodiments, network 105 is enabled to employ any form of computer readable media for communicating information from one electronic device to another. Also, in embodiments, network 105 includes a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router acts as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in embodiments, remote computers and other related electronic devices could be remotely connected to either LANs or WANs via a modem and temporary telephone link. In essence, in embodiments, network 105 includes any communication method by which information may travel between client devices 102-104, and servers 106 and 107.

### Example 2

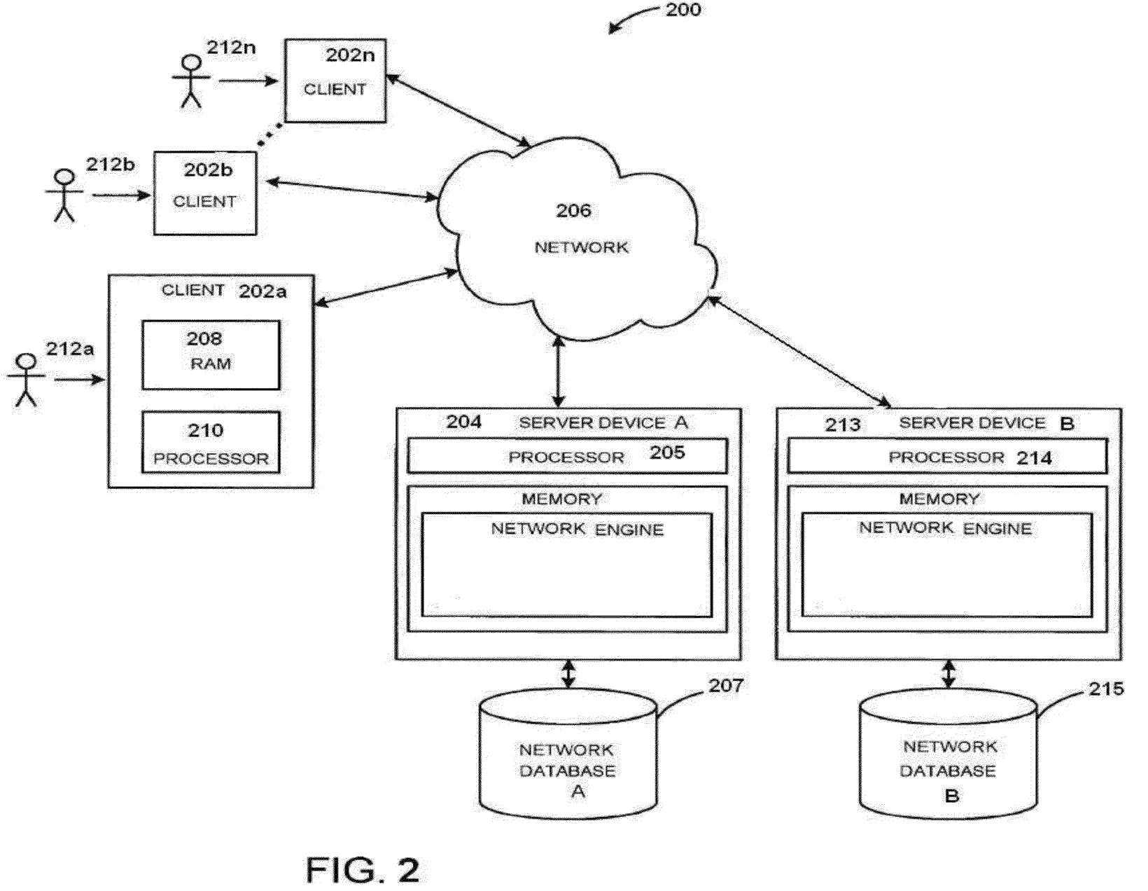

FIG. 2 shows another exemplary embodiment of the computer and network architecture that supports the inventive system. The client devices 202a, 202b thru 202n shown (electronic devices in the retail store) each comprises a computer-readable medium, such as a random access memory (RAM) 208 coupled to a processor 210 or FLASH memory. The processor 210 executes computer-executable program instructions stored in memory 208. Such processors comprise a microprocessor, an ASIC, and state machines. Such processors comprise, or are be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 210 of client 202a, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media transmit or carry instructions to a computer, including a router, private or public network, or other transmission device or channel, both wired and wireless. The instructions comprise code from any computer-programming language, including, for example, C, C++, C#, Visual Basic, Java, Python, Perl, and JavaScript.

Client devices 202a-n also comprise a number of external or internal devices such as a mouse, a CD-ROM, DVD, a keyboard, a display, or other input or output devices. Examples of client devices 202a-n are personal computers, digital assistants, personal digital assistants, cellular phones, mobile phones, smart phones, pagers, digital tablets, laptop computers, Internet appliances, and other processor-based devices. In general, a client device 202a are be any type of processor-based platform that is connected to a network 206 and that interacts with one or more application programs. Client devices 202a-n operate on any operating system capable of supporting a browser or browser-enabled application, such as Microsoft™, Windows™, or Linux. The client devices 202a-n shown include, for example, personal computers executing a browser application program such as Microsoft Corporation's Internet Explorer™, Apple Computer, Inc.'s Safari™, Mozilla Firefox, and Opera.

Through the client devices 202a-n, users 212a-n communicate over the network 206 with each other and with other systems and devices coupled to the network 206. As shown in FIG. 2, server devices 204 and 213 are also coupled to the network 206.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, Javascript). The aforementioned examples are, of course, illustrative and not restrictive.

### Example 3

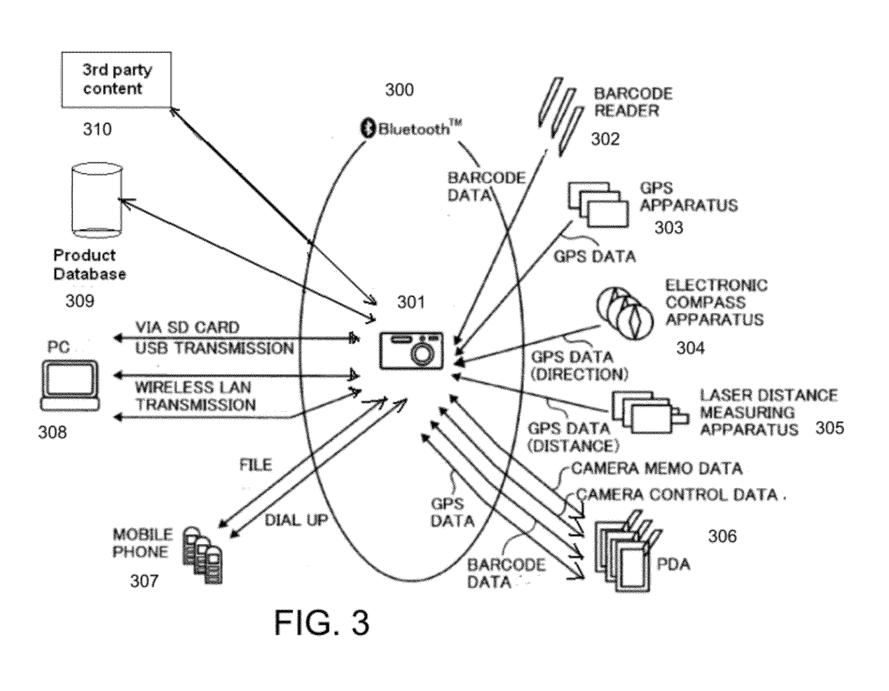

FIG. 3 illustrates a connection diagram for some embodiments of the present invention. FIG. 3 shows an exemplary displayed electronic product sold by the retail store (e.g., camera), showing how the displayed electronic product can electronically communicate with electronic devices of customers and/or other electronic devices in the store (e.g., interactive display showing product information about the product and/or similar products). In one example, the camera 301 can be connected to a barcode reader 302, GPS (Global Positioning System) apparatus 303, an electronic compass 304, and a laser distance measuring apparatus 305, and a customer's PDA 306 through various Bluetooth profiles 300. In another example, the camera 301 can be connected to a customer's mobile phone 307 and a PC (Personal Computer) 308 through Bluetooth profiles 300 (e.g., object push profile (OPP)). In yet another example, the camera 301 can be connected to a mobile phone 307 through Bluetooth profiles 300 (e.g., dial-up networking (DUN), etc.). In yet another example, the camera 301 dynamically communicates with at least one product database 309 of the retail store and/or any 3rd party source 310.

### Illustrative Embodiments of Computer Systems and Methods of the Instant Invention

### Example 4

In some embodiments, the inventive computer systems and methods can provide additional information about specific physical product sold in the retail store when a potential customer performs a single action to or with the specific physical product. In some embodiments, the single physical activity/action performed by the potential customer to receive information about the specific product can include, but not limited to:

a) the potential customer lifting the physical product from its place on a display of the retail store;

b) the potential customer touching the physical product (e.g., a touching a screen of the physical electronic device);

c) the potential customer activating in a single action a single control of the physical product (e.g., pressing/moving a key/button);

d) the potential customer engaging in the dynamic interaction related to the physical product by performing a single movement which is recognized by the specific physical product (e.g., the specific physical product recognizes customer's particular hand movement utilizing, for example, a camera or a wired glove and gesture recognition software);

e) any other suitable single action/activity that can allow the retail store to identify a specific product displayed by the retail store, for which the potential customer desires information.

In some embodiment, the single action/activity performed by the potential customer is an action/activity that is performed by the potential customer immediately after and/or as soon as, and without any intervening action, the potential customer is in a vicinity of a particular displayed physical product for which the potential customer desires information.

In some embodiments of the instant invention, the term “vicinity” means, but not necessarily limited to, an area of the retail store within which the physical product is located/displayed so that a particular customer is capable to directly observe the physical product without the customer's vision of the physical product being completely blocked by a physical structure of the retail store.

In some embodiments of the instant invention, the term “vicinity” means, but not necessarily limited to, the area of the retail store within which the physical product is located/displayed so that a particular customer is capable to physically reach the physical product in just a few steps or less. In some embodiments, the few steps corresponds to about 2 feet. In some embodiments, the few steps corresponds to about 5 feet. In some embodiments, the few steps corresponds to about 10 feet. In some embodiments, the few steps corresponds to about 15 feet. In some embodiments, the few steps corresponds to about 25 feet. In some embodiments, the few steps corresponds to less than about 25 feet. In some embodiments, the few steps corresponds to less than about 15 feet. In some embodiments, the few steps corresponds to less than about 10 feet.

In some embodiment, the single action/activity performed by the potential customer is an action/activity that is performed by the potential customer immediately after and/or as soon as, and without any intervening action, the potential customer is in a vicinity of a set of displayed physical products that include a particular physical product for which the potential customer desires information.

In some embodiments, the single action/activity is an action performed immediately after and/or as soon as, and without any intervening action, the potential customer is in the vicinity of the particular displayed physical product for which the potential customer desires information, but not necessarily immediately after the first time the potential customer is in the vicinity of the particular displayed physical product or every time that the potential customer is in the vicinity of the particular displayed physical product.

In some embodiments, the single action/activity is an action performed immediately after and/or as soon as, and without any intervening action, the potential customer is in the vicinity of a set of displayed physical products that include the particular displayed physical product for which the potential customer desires information, but not necessarily immediately after the first time the potential customer is in the vicinity of the set of displayed physical products that include the particular displayed physical product or every time that the potential customer is in the vicinity of the set of displayed physical products that include the particular displayed physical product.

### Example 5

In some embodiments, the potential customer can perform two or more actions/activities that can allow the retail store to identify a specific product displayed by the retail store, for which the potential customer desires information.

### Example 6

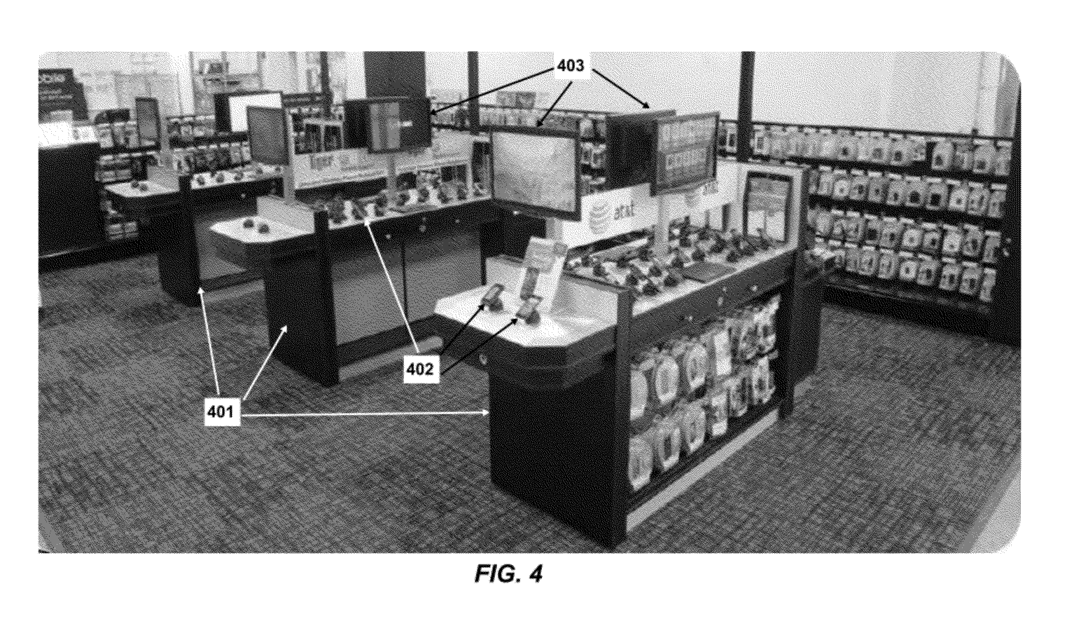

FIG. 4 shows a set of exemplary displays/stands (401) of an exemplary retail store. In some embodiments, as further shown in FIG. 4, each exemplary display (401) displays exemplary physical products (402) (e.g., smart phones, iPads, etc.). In some embodiments, as further shown in FIG. 4, each exemplary display/stand (401) can have a monitor (e.g., touch-screen capable monitor) (403) that can display information about and/or related to, for instance, but not limited to, each exemplary physical product (402). In some embodiments, each exemplary physical product (402) and the monitor (.g., touch-screen capable monitor) (403) are interconnected through and/or controlled by at least one computer processor and communicate with each other and the at least one computer processor using one or more of the following technologies, but not limited to, electronic communication (e.g., electronically wired), wireless communication (e.g., radio wave-based communication, laser-based communication) or any other similar suitable technology. In some embodiments, the monitor (.g., touch-screen capable monitor) (403) can display a piece of information (e.g., a picture) about each exemplary physical product (402) in a particular position on a screen of the monitor (403) that can corresponds to the physical location of each exemplary physical product (402) on the exemplary display (401) (e.g., same respective order and/or the same respective position in which each exemplary physical product (402) is located/displayed on the exemplary display (401).) For example, as FIG. 4 shows, that smart phones (402) can be displayed in two rows on an exemplary display/stand (401) and, respectively, the screen of the monitor (403) can display two rows of images where each image corresponds to a particular smart phone (402). For example, if the particular smart phone (402) is located in the rightmost position on a row of the exemplary display/stand (401) that is closer to an imaginary customer, then the image of this particular smart phone (402) would be shown in the rightmost position of the bottom row of images provided on the screen of the monitor (403).

In some embodiments, when a potential customer performs a single action on a specific exemplary physical product (402) by, for instance but not limited to, simply lifting one of the exemplary physical product (402) from its position on the exemplary display (401), such action results in real-time dynamic output to the exemplary monitor (403) information about and/or related to the specific exemplary physical product (402) that the customer has lifted. In some embodiments, the outputted information about and/or related to the specific exemplary physical product (402) can be restricted to an area of the screen of the monitor (403) that corresponds to the order and/or the same position in which the exemplary physical product (402) is positioned on the exemplary display (401)

In some embodiments, when a potential customer performs a single action to or with a specific exemplary physical product (402) by, for instance but not limited to, simply lifting one of the exemplary physical product (402) from its position on the exemplary display (401), such action results in real-time dynamic output to the exemplary monitor (403) information about and/or related to the specific exemplary physical product (402) that the customer has lifted. In one example, by simply lifting one of the exemplary physical product (402) from its position on the exemplary display (401), the customer, for example, breaks an electric circuitry which depends on the particular physical product (402) being attached to the exemplary display (401) which is recognized by an exemplary computer system of some embodiments of the instant invention. In some embodiments, the instant invention can use other suitable sensing technologies (e.g., breaking near field communication between the product (402) and he display (401)) to recognize that the customer lifted the exemplary physical product (402) from its position on the exemplary display (401).

In some embodiments, when a potential customer selects an information about and/or related to the specific exemplary physical product (402) on the exemplary monitor (403) (e.g., touches an image on the screen, clicks on the image on the screen), such action(s) can result in the “waking up” of the corresponding exemplary physical product (402) (e.g., displaying certain information, unlocking touch screen, etc.) so that the customer can readily identify the exemplary physical product (402) with its corresponding information shown on the exemplary monitor (403).

Consequently, in some embodiments, the instant invention allows for a two-way communication interaction between the exemplary physical product (402) and its corresponding information shown on the exemplary monitor (403), including, but not limiting to, customer's ability to control at least one functionality of the exemplary physical product (402) by interacting with the shown information (e.g., clicking/tapping on a play button shown the exemplary monitor (403) to play a media file on the exemplary physical product (402).)

### Example 7

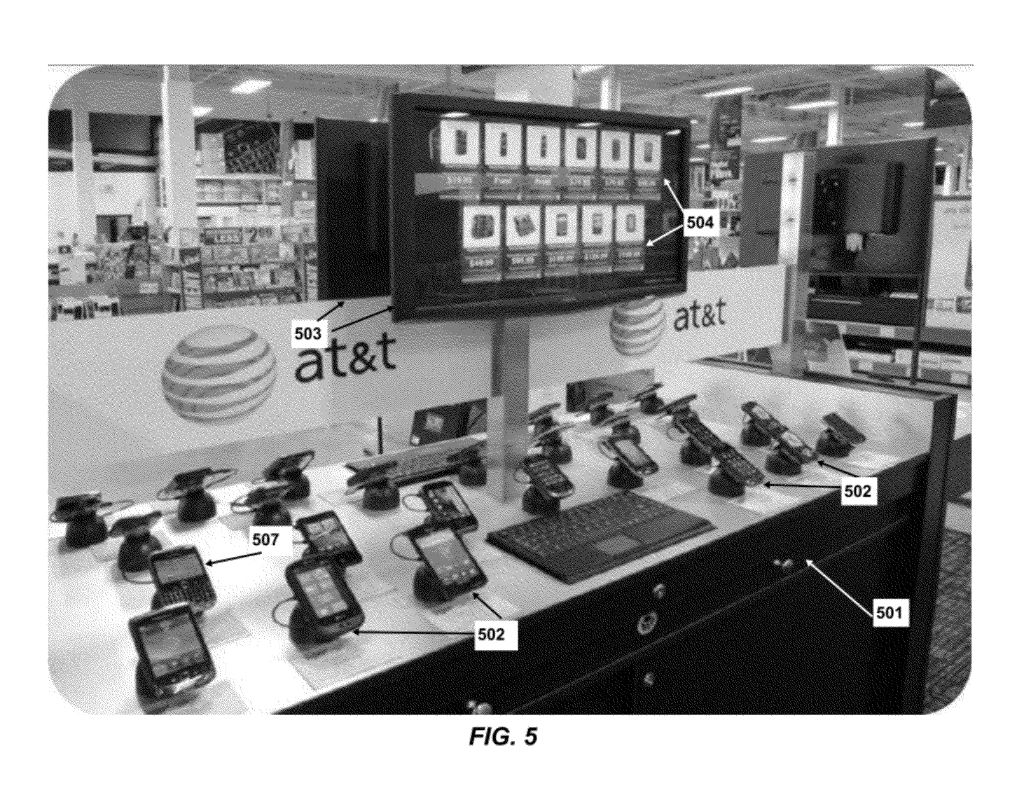

FIG. 5 shows another exemplary display/stand (501) of an exemplary retail store. In some embodiments, as further shown in FIG. 5, the exemplary display (501) can display, on each side, two rows of exemplary physical products (502) (e.g., smart phones offered by AT&T). In some embodiments, as further shown in FIG. 5, the exemplary display/stand (501) can have at least one monitor (e.g., touch-screen capable monitor) (503) that can display information (504) about and/or related to, for instance, but not limited to, each exemplary physical product (502). In one example, a screen of the monitor (503) can display images (504), in two rows, where each image corresponds to each particular product (502) out of a set of exemplary physical products (502) located, in two rows, on one side of the exemplary display (501). In another example, the screen of the monitor (503) can selectively display images (504) of some, not all, exemplary physical products (502) shown on the exemplary display (501). In some embodiments, at least one computer processor that is operatively connected to each or some exemplary physical products (502), and the monitor (503), programmed to selectively control the displayed information (504) and the dynamic, real-time interaction between exemplary physical products (502) and the shown information (504), including, but not limiting to, customer's ability to control at least one functionality of the exemplary physical product (502) by interacting with the shown information (504) (e.g., clicking/tapping on a play button shown the exemplary monitor (503) to play a media file on the exemplary physical product (502).)

### Example 8

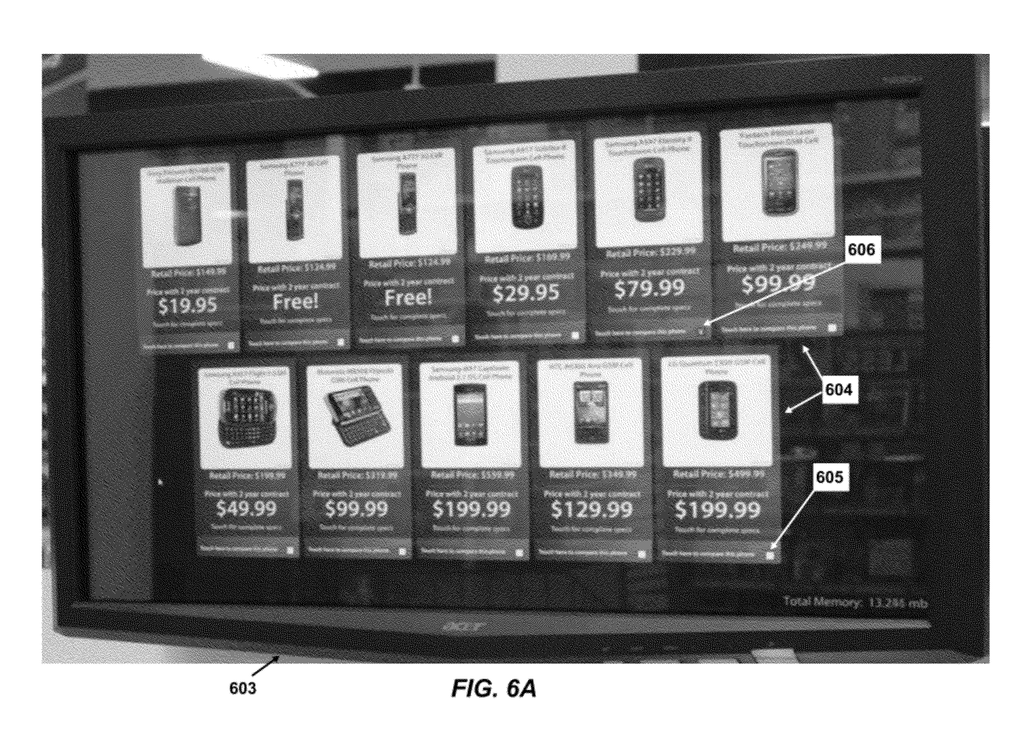

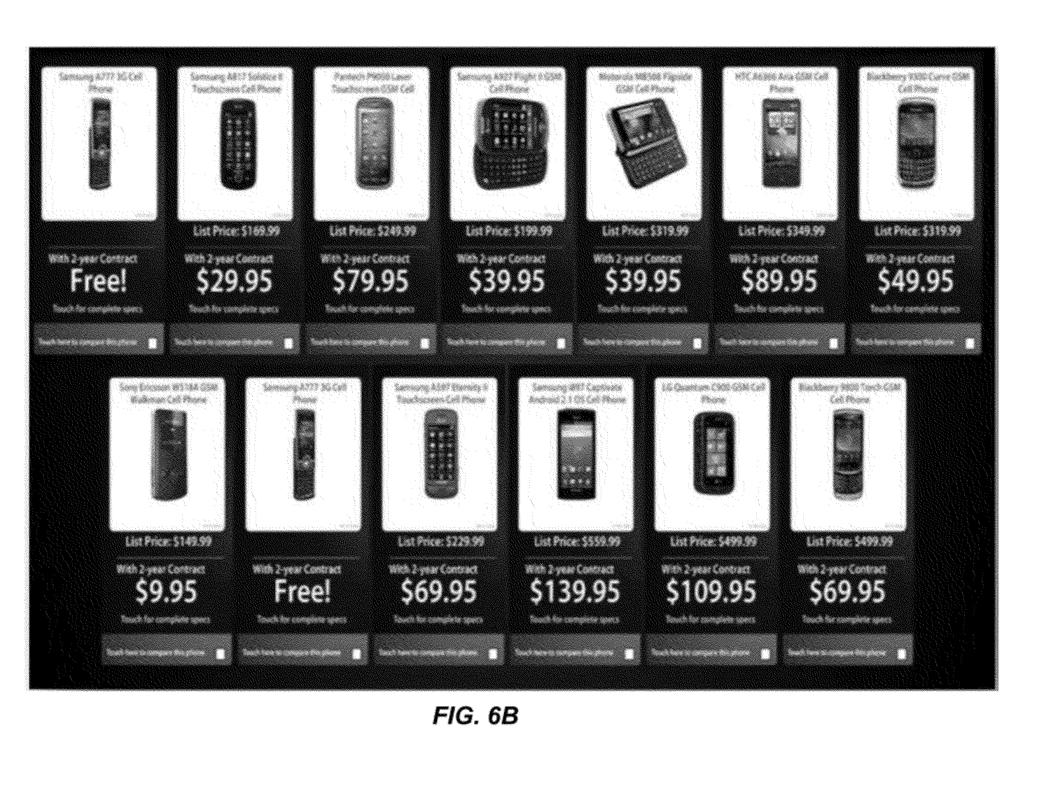

FIGS. 6A and 6B show close-up illustrations of screens of the exemplary monitor (603) that displays information about the associated physical products through images (604) in accordance with some embodiments of the instant invention. In one example, as shown in FIGS. 6A and 6B, the customer can interactively learn about a particular physical product by clicking on a particular image (604) displayed by the exemplary monitor (603) that is associated with the particular physical product of interest. In another example, the customer can interactively compare particular physical products by selecting, for example, options (605, 606) on the bottom of the images (604). In another example, the option (606) has changed its appearance to indicate that the customer has selected the associated device to be compared against another device shown on the screen of the exemplary monitor (603).

In some embodiments, the instant invention can allow the customer to compare physical products that are associated with different displays/stands (401, 501) by storing the customer's selection(s) associated with each display/stand (401, 501) in one or more databases of the retail store. In some embodiments, the instant invention can allow the customer to compare physical products that the customer selected during different visits of the same retail store. In some embodiments, in case of the retail store includes a plurality of associated retail stores (e.g., a chain of retail stores), the instant invention can allow the customer to compare physical products that the customer selected during visits of different retail stores among the plurality of associated retail stores.

### Example 9

In some embodiments, the instant invention can store/track, for example, customer's shopping experience continuously and/or over certain period time (e.g., minute(s), hour(s), day(s), month(s), year(s).) In some embodiments, in case of the retail store includes a plurality of associated retail stores (e.g., a chain of retail stores), the instant invention can store/track, for example, customer's shopping experience over the plurality retail stores. In some embodiments, in case of the retail store includes a plurality of associated retail stores (e.g., a chain of retail stores), the instant invention can store/track, for example, customer's shopping experience over the plurality retail stores and/or for a period of time—i.e., continuously and/or over certain period time (e.g., minute(s), hour(s), day(s), month(s), year(s).)

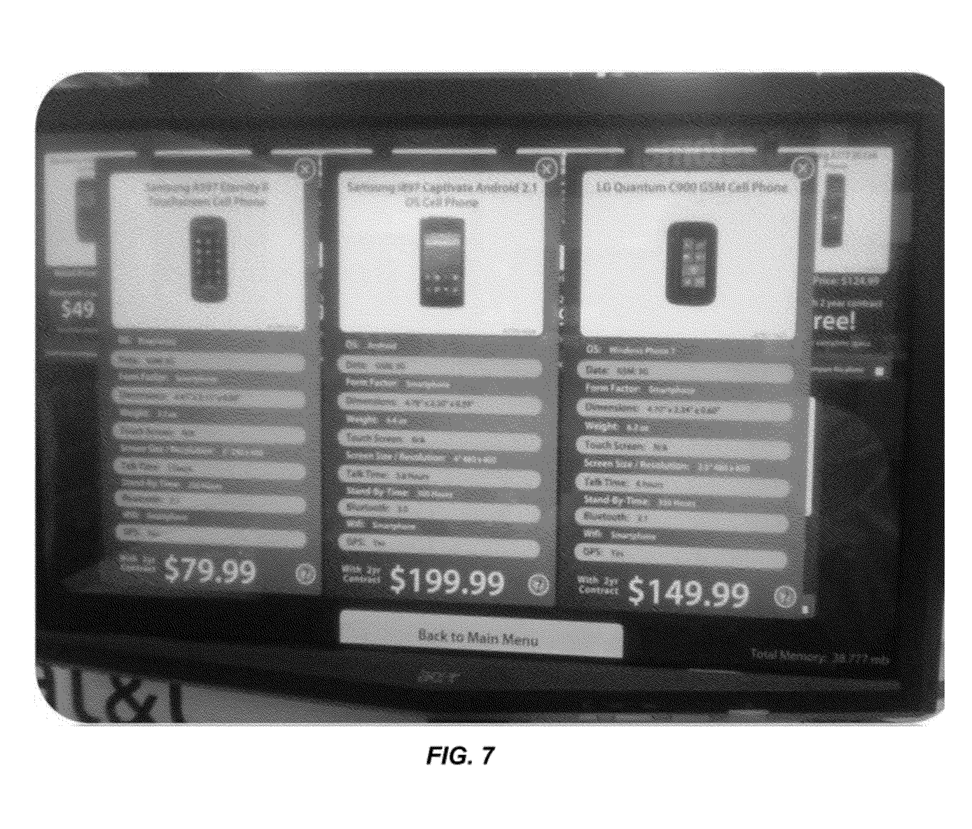

In one example, as shown in FIG. 7, the customer has identified 3 physical products for comparing information (e.g., operating system, functions, CPU, memory, price, etc.,) about those 3 products.

### Example 10

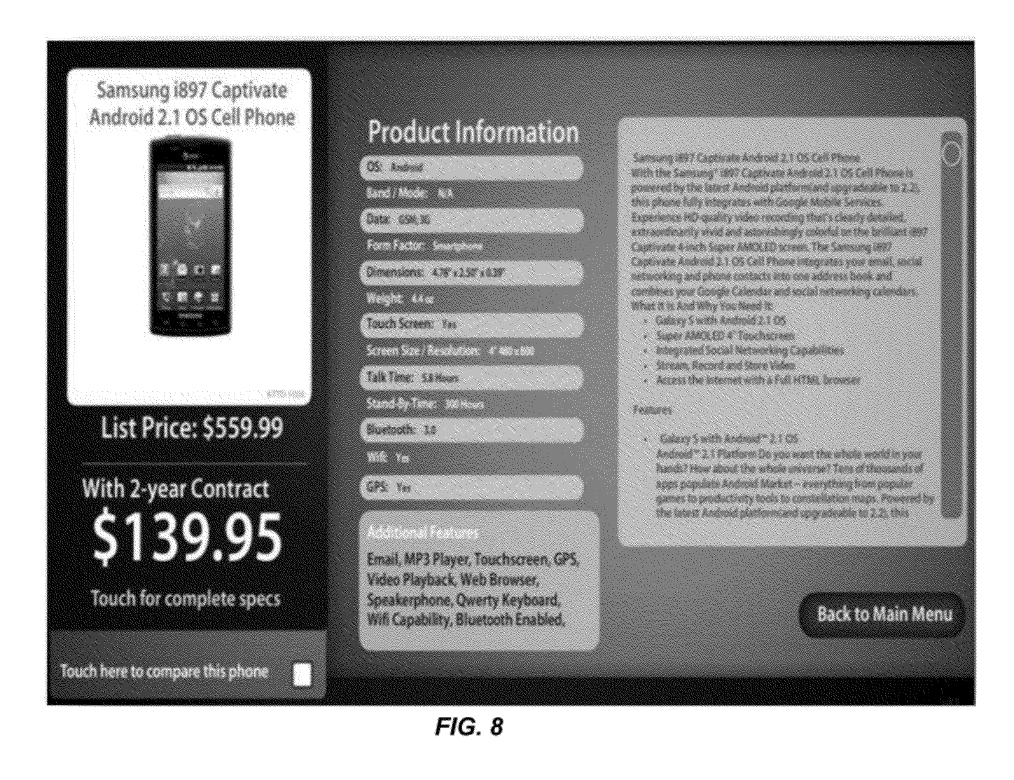

In some embodiments, when a customer activates a particular physical product (e.g., lifting the physical product from its place on the display/stand (e.g., 401 of FIG. 4, 501 of FIG. 4), touching the physical product, communicating with the product (e.g., through NFC)) or select an associated information (e.g., image) (e.g., 604 of FIG. 6A) on the screen of associated monitor (e.g., 603 of FIG. 6A), the instant invention can provide information about the product. In one example, the provided information can be, for example, in a format shown in FIG. 8. In another example, the provide information can feature specification of main features of the product (e.g., operating system, battery life, Wi-Fi availability, etc.).

### Example 11

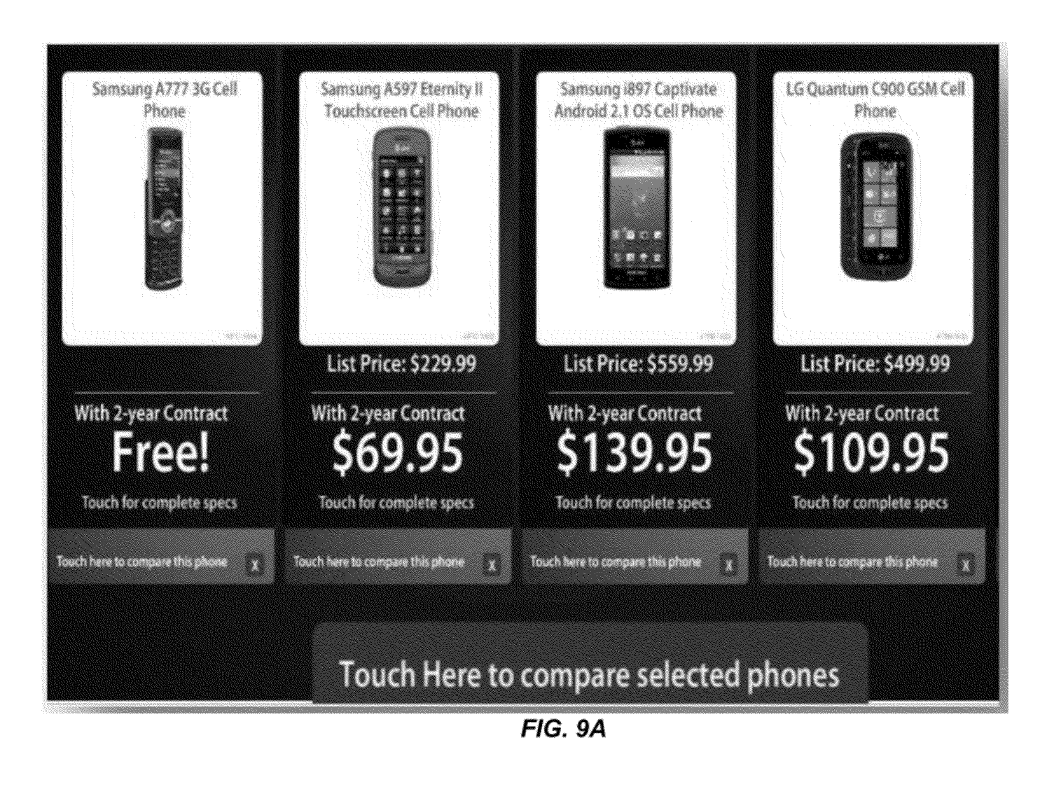

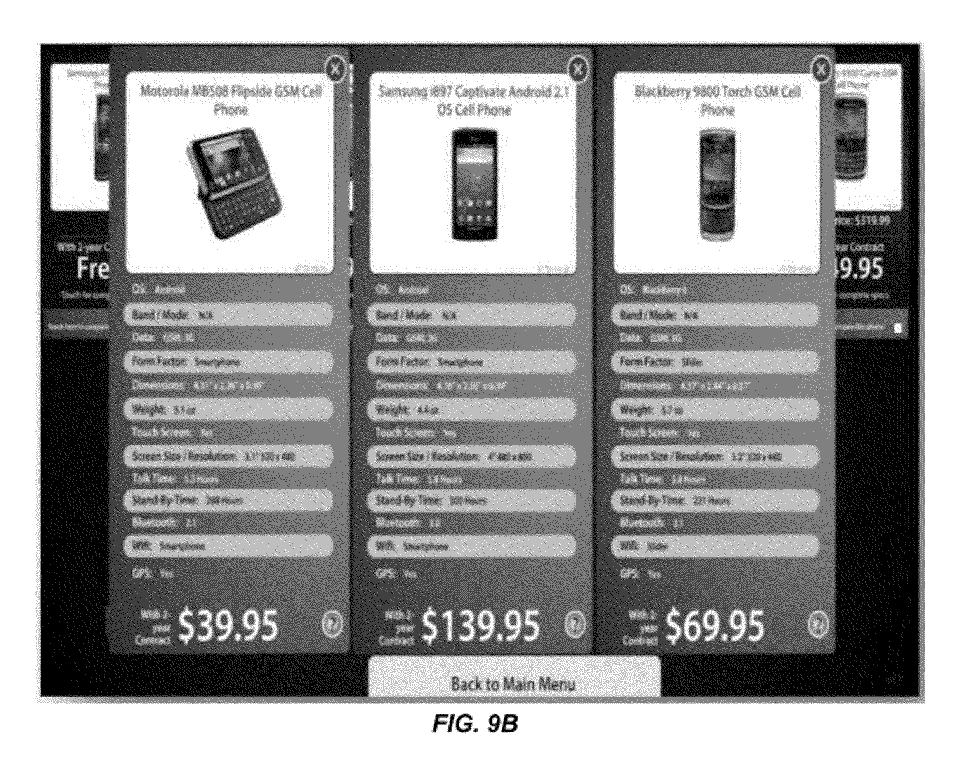

FIGS. 9A and 9B illustrate some other embodiments of the present invention that can provide an ability to view a side-by-side comparison of each physical product located on a particular display/stand. In one example, if, for example, more than 3 products are selected by a customer for the comparison, a screen, if it is a touch screen, can allow to “slide” on-the-screen information to get additional information. In another example, the instant invention can allow the customer to always retain on the screen the information for a particular product, as a reference, and “slide”/“scroll” information of other products in the comparison that cannot be fitted on the some screen with the retained information of the particular product.

### Example 12

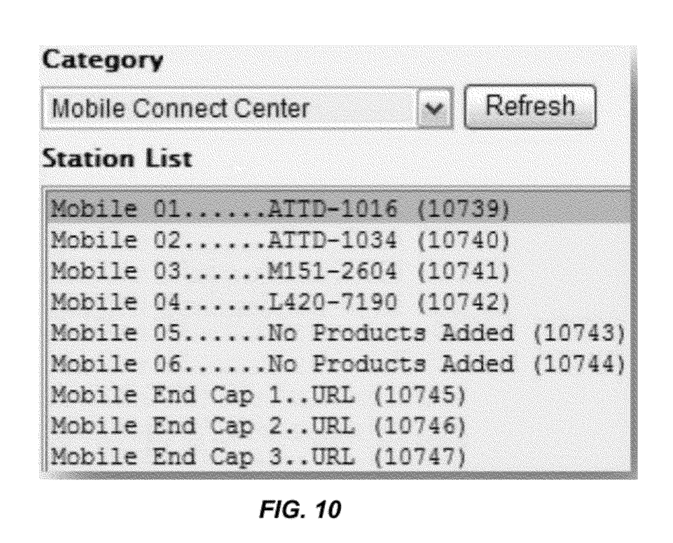

In some embodiments, as shown in FIG. 10, the instant invention can utilize a computer program to program/set-up the associations between each particular physical product and its corresponding location on a display/stand. In one example, as shown in FIG. 4, there could be a total of 6 product stations (2 on each side of each of the 3 shown displays/stands (401).) For example, items “Mobile 01” through “Mobile 06,” identified in FIG. 10, are designations of particular product locations on a single product station (e.g., “Mobile 01” corresponds to rightmost position in the first row (507 of FIG. 5) that would be the farthest row from a customer facing the product station). Also, as shown FIG. 4, each of the 3 shown displays/stands could have an end cap station with additional displayed products (e.g., smart phones (402).) For example, items “Mobile End Cap 1” through “Mobile End Cap 3,” identified in FIG. 10, are designations that respectively correspond to each of end cap stations of the 3 shown displays/stands (401).) In one example, as shown in FIG. 10, the end cap stations can be assigned a URL to certain media content (e.g., product advertisement, store advertisements, store promotions, etc.) that can be played on one or more products located in the end cap station and/or on a monitor associated with a particular end cap station. In another example, each end cap station can have customized media content provided to it. In another example, one or more products located on the end cap stations and/or the associated monitors can remain idle all the time while the retail store is opened. In yet another example, one or more products located on the end cap stations and/or the associated monitors can remain idle during one or more pre-determined time periods.

In some embodiments, each or some of physical products located on the product stations of the displays/stands of the store can remain idle all the time while the retail store is opened. In some embodiments, each or some of physical products located on the product stations of the displays/stands of the store can remain idle during one or more pre-determined time periods.

### Example 13

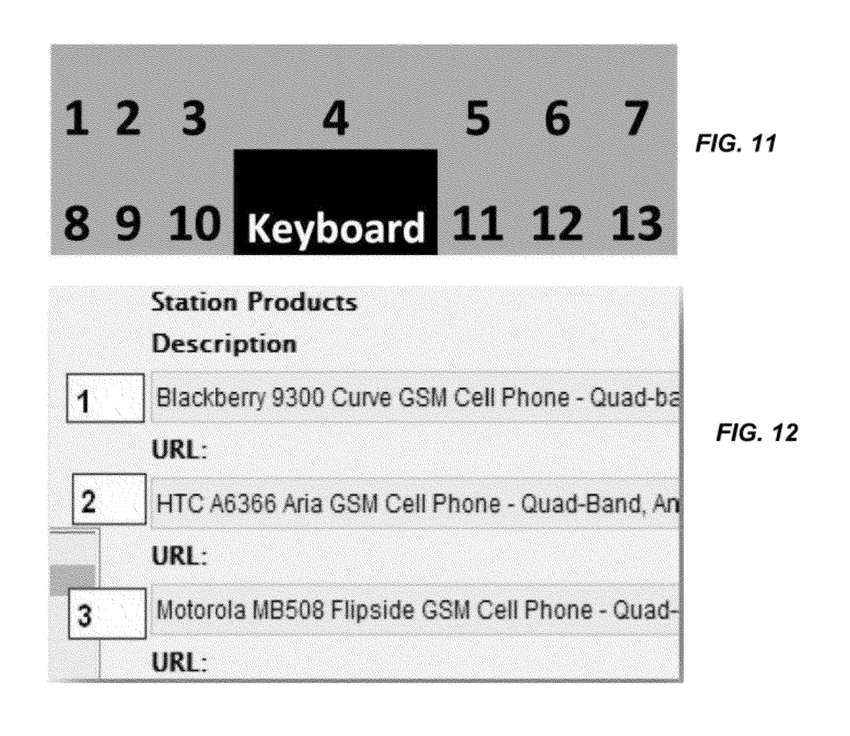

In some embodiments, as shown in FIGS. 11 and 12, there could be, for example, 13 physical products (e.g., smart phones) located on a particular product station (e.g., 501 of FIG. 5). In some embodiment, an employee of the retail store can associate products to be displayed on a particular product station in accordance to a planogram shown in FIG. 11. In one example, as shown in FIG. 12, the employee can assign the position 1 on the product station of a particular display/stand to, for instance, a Blackberry 9300 product, by inputting SKU1 corresponding to this product into a look-up table utilized by one or more computer processors that manage the particular display/stand. In another example, as shown in FIG. 12, the employee can assign the position 2 on the product station of the particular display/stand to, for instance, a HTC A6366 cell phone product, by inputting SKU2 corresponding to this product into the look-up table utilized by one or more computer processors that manage the particular display/stand. In another example, as shown in FIG. 12, the employee can assign the position 3 on the product station of a particular display/stand to, for instance, a Motorola MB08 cell phone product, by inputting SKU3 corresponding to this product into the look-up table utilized by one or more computer processors that manage the particular display/stand.

### Example 14

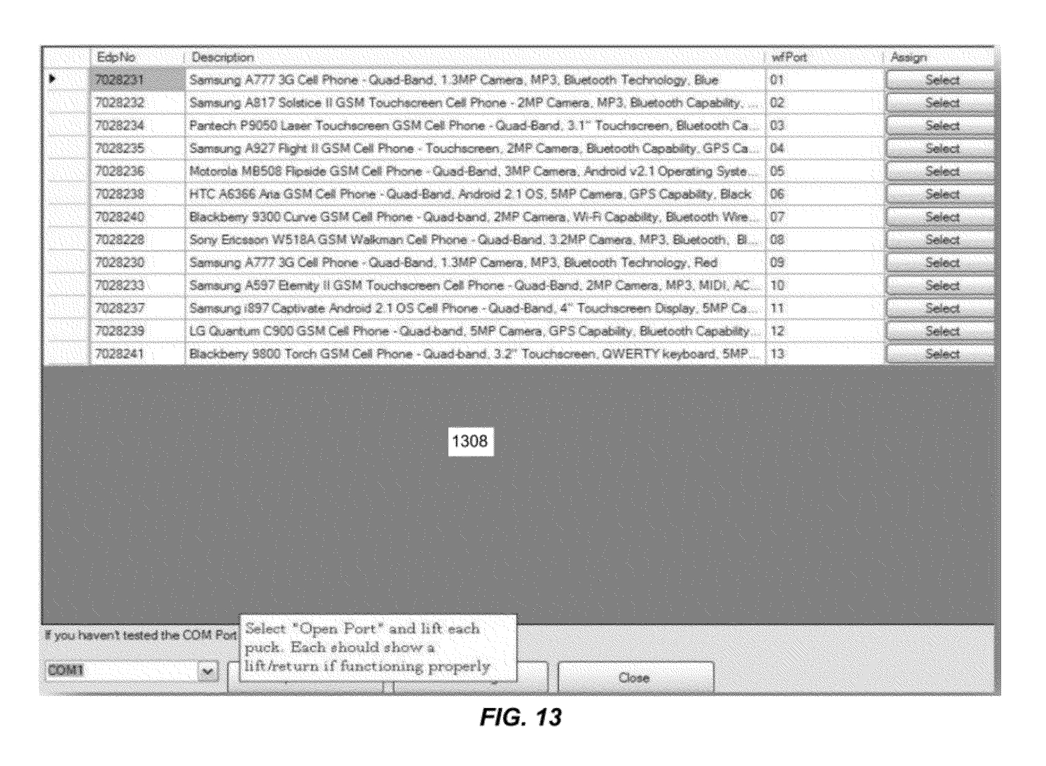

In some embodiments, as shown in FIG. 13, once all products have been assigned in station master to theirs corresponding locations in accordance with the planogram of FIG. 11, the employee can utilize a programmed interface of FIG. 13 to assign each product to a particular docking mount (e.g., a puck). In one example, docking mounts can detect its absolute position and/or rotation/movement and relate the detected position/rotation to one or more processors that dynamically, real-time manage the operation of the particular display/stand, including products located on the display/stand. In another example, docking mounts can detect absolute position and/or rotation/movement of a product attached to such docking mount and relate the detected information to one or more processors that dynamically, real-time manage the operation of the particular display/stand, including products located on the display/stand.

In some embodiments, after the assignment described above is complete, even if a particular product is not selected by a customer on a screen, the interface of FIG. 13 can register (e.g., receives a message) each time the particular product is lifted and each time the particular product is returned to its position on the display/stand. In one example, a message can be provided in a box (1308) that indicates whether the particular product is lifted or returned.

### Example 15

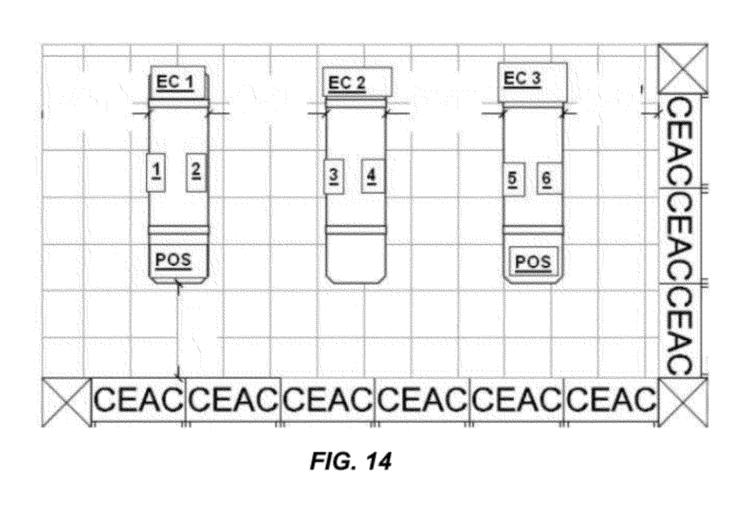

FIG. 14 shows another layout of a retail store that can be utilized by some embodiments of the instant invention. In FIG. 14, the product stations of displays/stands are identified with numbers 1 through 6. In FIG. 14, EC1 to EC3 are the end cap operating similar to ones described above. In FIG. 14, point-of-sale terminals are identified as “POS.” In some embodiments, EC1 to EC3 can play commercials streamed from local (e.e.g, in store content server) and/or remote sources (e.g., Internet).

### Example 16

In some embodiments, the inventive computer systems and methods can allow customers to interact with: (a) physical products displayed in retail stores, (b) interactive monitors associated with the store's displays/stands; (c) retail stores' POS; d) salespersons; e) retail store's computer systems; and/or e) other electronic devices that are utilized to operate a retail store,—by utilizing one or more of the communication technologies further described therein.

In some embodiments, the utilized communication technologies can include dynamically generated QR code to point to either promotional offer or content via mobile device portable of scanning standardized 2D QR code or other code formats. A QR Code (“Quick Response”) is a matrix code (or two-dimensional bar code), which allow for its contents to be decoded at high speed. In some embodiments, QR codes store addresses and URLs. In some embodiments, shoppers with a camera phone equipped with the correct reader software may scan the image of the QR Code displayed through an electronic device by the inventive computer system causing the phone's browser to launch and redirect to the programmed URL. This act of linking from physical world objects is known as a hardlink or physical world hyperlinks. For example, Google's mobile Android operating system supports the use of QR codes by natively including the barcode scanner (ZXing) on some models and the browser supports URI redirection, which allows QR Codes to send metadata to existing applications on the device. Another example, Nokia's symbian operating system is also provided with a barcode scanner, which is able to read QR Codes.

In some embodiments, the utilized communication technologies can provide a retail store's customers with an integrated capability to ‘share’ product via social networking or other api enabled applications. In some embodiments, the inventive computer system and methods may allow shoppers to send a product description link (with or without price) to their Facebook or Twitter accounts.

In some embodiments, the inventive computer system and methods may include an integrated service sales link to launch a product selection and ordering tool. In some other embodiments, the selection and ordering tool is user-configurable.

In some embodiments, the inventive computer system and methods may utilize devices that can communicate via IEEE 802.11b, a wireless networking standard. For example, a retail store may sell a digital camera with an IEEE 802.11b transmitter and a printer incorporating wireless chipsets.

In some embodiments, the inventive computer system and methods may utilize devices with technologies such as NetSense, UPnP, iReady, Bluetooth as a communication medium.

In one embodiment, a system comprises a host application executing on, for example, a retail store's server, and one or more networked devices (wireless and/or wired network) executing a client application. A networked device can include any capable electronic device such as a consumer appliance equipped with network capability, a digital device such as MP3 players and DVRs, an electronically-controlled device such as a light circuit or other type of circuit, and the like.

In some embodiments, the host application automatically establishes communication with the networked device. First, the networked device can automatically access a network (e.g., a wireless network having a DHCP service) on which it can broadcast a network address and service. The host application can sense the broadcast and automatically establish communication with the network appliance while registering the service.

In another embodiment, the networked device dynamically configures a user interface for customer's control of the networked device. To do so, the networked device can transmit user interface information that specifies components of a user interface. The user interface information can be structured in an open format. The components are related to application level control of the service provided by the network appliance. For example, the networked device can use XML to format name-value pairs, i.e., names of components and current values associated with the components. The host then generates the user interface from a component repository and sets values as indicated by the networked device.

In some embodiments, the user interface can also display components related to lower level control such as an information about the networked device (e.g., on, off, online, offline, error, product category, UPC, and the like); communications configuration (e.g., IP address, port, network connection, and the like); position intelligence (e.g., data from Global positioning system (GPS), position on a floor plan, etc.) and/or location intelligence (neighboring networked/non-networked device(s)).

In yet another embodiment, the host application can provide a graphical layout of the networked device. Accordingly, the host application can display a floor plan or pictures of the environment containing the networked device (e.g., pictures of a showroom). In some embodiments, the on-screen layout/interface has a consistent and recognizable format across different networked devices, but is nevertheless customized to capabilities of the networked device.

In some embodiments, while in a physical retail store, customers' electronic devices (e.g., PDAs, smart phones, iPADs, etc.) acquire data communicated by codes embedded in the on-screen layouts of displayed electronic products/or product information monitors, by using any suitable means, such as wireless technology (e.g., WiMAX, Thunderbolt, LTE, NFC, etc.). WiMAX (Worldwide Interoperability for Microwave Access) is a telecommunications protocol that provides fixed and mobile Internet access.

In some embodiments, the displayed electronic products communicate data encoded in codes (e.g., QR code, UPC code, etc.), by utilizing Near field communications, or NFC, which is a set of short-range wireless technologies, typically requiring a distance of 4 cm or less. NFC operates at 13.56 MHz and at rates ranging from 106 kbit/s to 848 kbit/s. NFC always involves an initiator and a target; the initiator typically actively generates an RF field that can power a passive target.

In some embodiments, the displayed electronic products of the store are initiators and customers' electronic devices are targets. This enables NFC targets to take very simple form factors such as tags, stickers, key fobs, or cards that do not require batteries.

In some embodiments, the displayed electronic products of the store are targets and customers' electronic devices are initiators. In some embodiments, NFC peer-to-peer communication is also possible, where both devices are powered.

In some embodiments, NFC can be an open platform technology standardized in, for instance, ECMA-340 and ISO/IEC 18092 standards. These standards specify the modulation schemes, coding, transfer speeds and frame format of the RF interface of NFC devices, as well as initialization schemes and conditions required for data collision-control during initialization for both passive and active NFC modes. Furthermore, they also define the transport protocol, including protocol activation and data-exchange methods.

In some embodiments, customers' electronic device may utilize the CCD (Charge Coupled Device) which is a solid state image pickup device for elecro-optically converting the optical image of a code, and the F/E-IC (Front End Integrated Circuit) includes a CDS (Correlation Double Sampling) circuit for performing correlation double sampling used to remove image noise, an AGC (Automatic Gain Control) for performing gain adjusting, an A/D (Analog-to-Digital) converter for performing digital signal conversion, a CCD mechanism which is typically supplied with a vertical synchronization signal (hereinafter, referred to as a VD) and a horizontal synchronization signal (hereinafter, referred to as an SD) from the CCD and controlled by a CPU, and a TG (Timing Generator) for generating a driving timing signal for the F/E-IC.

In some embodiments, the location specific content includes real-time information which is location and station specific, accessed from the cloud via store location identifiers. In some embodiments, this real time data includes product specific pricing, inventory, content, manuals and/or other information as appropriate for the specific item.

In some embodiments, the instant invention can include at least one computer system of a physical retail store performing the following method that can at least include the steps of: determining a single action performed by a customer to or with at least one physical product, where the at least one physical product is provided in the physical retail store, and where the at least one physical product is accessible to the customer who visit the physical retail store; where the single action is an action that is performed by the visiting customer immediately after or as soon as, and without any intervening action, the visiting customer is in a vicinity of the at least one physical product; and providing to the visiting customer, a product information about the at least one physical product in response to the action performed by the visiting customer.

In some embodiments, the single action can be one of the following: a) the visiting customer lifts the at least one physical product from a display of the physical retail store, b) the visiting customer touches the at least one physical product, c) the visiting customer activates in the single action at least one control of the at least one physical product, or d) the visiting customer engages in a dynamic interaction related to the at least one physical product by performing a single movement which is recognized by the at least one physical product or by the computer system of the physical retail store.

In some embodiments, the vicinity of the at least one physical product can further include a plurality of physical products displayed by the physical retail store.

In some embodiments, the providing, by the computer system of the physical retail store, to the visiting customer, the product information about the at least one physical product can further include displaying the product information about the at least one physical product on a monitor located within the vicinity of the at least one physical product.

In some embodiments, the providing, by the computer system of the physical retail store, to the visiting customer, the product information about the at least one physical product can further include receiving, by the computer system of the physical retail store, at least one request regarding the displayed product information about the at least one physical product.

In some embodiments, the receiving, by the computer system of the physical retail store, the at least one request regarding the displayed product information about the at least one physical product can further include allowing the visiting customer to submit the at least one request by interacting with the monitor. In some embodiments, the allowing the visiting customer to submit the at least one request by interacting with the monitor can further include providing a touch screen which is capable of communicating the at least one request that the visiting customer submits by utilizing the touch screen.

In some embodiments, the determining the single action performed by the visiting customer to the at least one physical product can further include determining, by the computer system of the physical retail store, when the visiting customer touches, in the single action, a touch screen of a monitor located within the vicinity of the at least one physical product, where the touch of the visiting customer is within an area of the touch screen which is associated with the at least one physical product.

In some embodiments, the providing, to the visiting customer, the product information about the at least one physical product in response to the action performed by the visiting customer can further include providing, by the computer system of the physical retail store, to the visiting customer, at least one visual or audio indication that identifies the at least one physical product among other physical products located in the vicinity of the at least one physical product. In some embodiments, the at least one visual or audio indication is produced by the at least one physical product. In some embodiments, the at least one visual or audio indication is produced by a location of the at least one physical product.

In some embodiments, the local or individualized content may be determined by customers. While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A computer-implemented method, comprising
a) providing at least one physical product in a physical retail store,
wherein the at least one physical product is accessible to a customer who visit the physical retail store;
b) determining, by a computer system of the physical retail store, a single action performed by the visiting customer to or with the at least one physical product,
wherein the single action is an action that is performed by the visiting customer immediately after or as soon as, and without any intervening action, the visiting customer is in a vicinity of the at least one physical product;
c) providing, by the computer system of the physical retail store, to the visiting customer, a product information about the at least one physical product in response to the action performed by the visiting customer.

2. The computer-implemented method of claim 1, wherein the single action is one of the following:
a) the visiting customer lifts the at least one physical product from a display of the physical retail store,
b) the visiting customer touches the at least one physical product,
c) the visiting customer activates in the single action at least one control of the at least one physical product, or
d) the visiting customer engages in a dynamic interaction related to the at least one physical product by performing a single movement which is recognized by the at least one physical product or by the computer system of the physical retail store.

3. The computer-implemented method of claim 1, wherein the vicinity of the at least one physical product comprises a plurality of physical products displayed by the physical retail store.

4. The computer-implemented method of claim 1, wherein the providing, by the computer system of the physical retail store, to the visiting customer, the product information about the at least one physical product further comprises:
displaying the product information about the at least one physical product on a monitor located within the vicinity of the at least one physical product.

5. The computer-implemented method of claim 4, wherein the providing, by the computer system of the physical retail store, to the visiting customer, the product information about the at least one physical product further comprises:
receiving, by the computer system of the physical retail store, at least one request regarding the displayed product information about the at least one physical product.

6. The computer-implemented method of claim 5, wherein the receiving, by the computer system of the physical retail store, the at least one request regarding the displayed product information about the at least one physical product further comprises:
allowing the visiting customer to submit the at least one request by interacting with the monitor.

7. The computer-implemented method of claim 6, wherein the allowing the visiting customer to submit the at least one request by interacting with the monitor further comprises:
providing a touch screen which is capable of communicating the at least one request that the visiting customer submits by utilizing the touch screen.

8. The computer-implemented method of claim 1, wherein the determining the single action performed by the visiting customer to the at least one physical product further comprises:
determining, by the computer system of the physical retail store, when the visiting customer touches, in the single action, a touch screen of a monitor located within the vicinity of the at least one physical product,
wherein the touch of the visiting customer is within an area of the touch screen which is associated with the at least one physical product;

9. The computer-implemented method of claim 8, wherein the providing, to the visiting customer, the product information about the at least one physical product in response to the action performed by the visiting customer further comprises:
providing, by the computer system of the physical retail store, to the visiting customer, at least one visual or audio indication that identifies the at least one physical product among other physical products located in the vicinity of the at least one physical product.

10. The computer-implemented method of claim 9, wherein the at least one visual or audio indication is produced by the at least one physical product.

11. The computer-implemented method of claim 9, wherein the at least one visual or audio indication is produced by a location of the at least one physical product.
